(19) United States
(12) Patent Application Publication
(10) Pub. No.: US 2024/0261725 A1
(43) Pub. Date: Aug. 8, 2024

(54) HIGH RECOVERY CO AND CO2 SEPARATION PROCESS FROM FLUE GAS FROM A PARTIAL BURN FLUID CATALYTIC CRACKING PROCESS

(71) Applicant: UOP LLC, Des Plaines, IL (US)

(72) Inventors: Sakthivelan Maadasamy Durai, Haryana (IN); Jan De Ren, Arlington Heights, IL (US); Shubhra J. Bhadra, Naperville, IL (US); Erick J. Bennett, III, New Lenox, IL (US)

(21) Appl. No.: 18/424,123

(22) Filed: Jan. 26, 2024

Related U.S. Application Data
(60) Provisional application No. 63/483,790, filed on Feb. 8, 2023.

(51) Int. Cl. B01D 53/60; B01D 53/04; B01D 53/047; B01D 53/26; B01D 53/34; B01J 8/18; B01J 8/26; F25J 3/02

(52) U.S. Cl. CPC B01D 53/60; B01D 53/0462; B01D 53/047; B01D 53/0476; B01D 53/26; B01D 53/343; B01J 8/1827; B01J 8/1836; B01J 8/26; F25J 3/0219; F25J 3/0261; F25J 3/0266; B01D 2256/20; B01D 2256/22; B01D 2257/504; B01D 2258/0283; B01D 2259/65; B01J 2208/00274; F25J 2205/04; F25J 2210/70; F25J 2245/02

(57) ABSTRACT

Processes for separating CO from CO₂ in flue gas streams from partial oxidation regenerator in FCC processes, as well as reducing the sulfur content of the flue gas stream are described. The processes involve separating the cooled reactor effluent stream into a CO₂ product stream, the CO₂ recycle stream, and a CO product stream. The processes may incorporate either dry sorbent injection (DSI) units or wet gas scrubbing units to remove sulfur compounds. The separation processes can utilize cryogenic fractionation, pressure swing adsorption (PSA) processes including vacuum PSA, and temperature swing adsorption (TSA) processes. The flue gas stream can be used to preheat the CO₂ recycle stream.

### RELATED APPLICATIONS

This application claims priority to U.S. Provisional Patent Application Ser. No. 63/483,790, filed on Feb. 8, 2023, the entirety of which is incorporated herein by reference.

### BACKGROUND

Fluid catalytic cracking (FCC) is a hydrocarbon conversion process accomplished by contacting hydrocarbons in a fluidized reaction zone with a catalyst composed of finely divided particulate material. The reaction in catalytic cracking, as opposed to hydrocracking, is carried out in the absence of substantial added hydrogen or the consumption of hydrogen. As the cracking reaction proceeds substantial amounts of highly carbonaceous material referred to as coke is deposited on the catalyst. A high temperature regeneration operation within a regenerator zone combusts coke from the catalyst. Coke-containing catalyst, referred to herein as coked catalyst, is continually removed from the reaction zone and replaced by essentially coke-free catalyst from the regeneration zone. Fluidization of the catalyst particles by various gaseous streams allows the transport of catalyst between the reaction zone and regeneration zone. Spent catalyst from the reaction zone can be completely or partially regenerated in the regeneration zone.

The regenerator zone can be a complete burn unit or a partial burn unit. In a complete burn regenerator unit, the carbon in coke is combusted to CO2 releasing heat which is recovered. In a partial burn regenerator unit, the carbon in coke is partially combusted to CO2 and the rest to CO. The flue gas contains CO, typically up to about 10%, and more specifically between about 2% to about 5%, which is used as the primary fuel source in a downstream CO boiler or combustion chamber where the CO is combusted to CO2 releasing heat which is recovered. By running regenerator in a partial burn mode to maximize the CO yield, the unit will limit the amount of heat released in the regenerator relative to complete burn of the carbon to CO₂. This will lower the regenerator temperature and permit a higher catalyst to oil ratio in the FCC riser.

Conventional treatment of flue gas from FCC units and fluidized bed dehydrogenation units involves the use of wet gas scrubbing technology, such as a caustic scrubber, to remove sulfur compounds from the flue gas. In this process, the flue gas from the FCC regenerator is heat exchanged with boiler feed water to make steam and cool the flue gas. The flue gas is further cooled from a temperature of 205-315° C. to a temperature of 35-100° C. using a water quench. The cooled flue gas is contacted with NaOH which reacts with the sulfur compounds to form Na₂SO₃ and/or Na₂SO₄ and water, which are removed. The flue gas can optionally be heated and treated to remove nitrogen compounds. Alternately, other suitable reagents or sea water can be used for removing the sulfur compounds in the flue gas. The flue gas can also optionally be treated to remove catalyst fines and other particulate. The treated flue gas can then be discharged to the atmosphere.

The alternate process involves the use of a dry sorbent injection (DSI) unit or a slurry reagent injection (SRI) unit to remove sulfur compounds from flue gas. In this process, the flue gas from the FCC regenerator is heat exchanged with boiler feed water to make steam and cool the flue gas. The flue gas is then sent to a DSI unit to remove the sulfur compounds, and then to an economizer (or heat exchanger) to heat boiler feed water, thermal oil, or combustion air. Because the flue gas temperature does not reduce as much as with a wet scrubber process, additional thermal energy can be recovered from the flue gas in a DSI/SRI process.

The decontamination reactor of DSI unit may contain a reactant, such as one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, and (Ca(OH)₂·(Mg(OH)₂). The decontamination reactor converts one or more of the compounds in the flue gas stream.

The decontamination reactor effluent stream is filtered to remove one or more of NaHCO₃, Na₂CO₃, NaHCO₃·Na₂CO₃·2(H₂O), Na₂CO₃·2Na₂CO₃·3(H₂O), CaCO₃, Ca(HCO₃)₂, Ca(OH)₂, Mg(OH)₂, CaO, CaCO₃·MgCO₃, (Ca(OH)₂·(Mg(OH)₂), Na₂SO₄, NaNO₃, NaNO₂, Na₂CO₃, K₂SO₄, KNO₃, catalyst fines and fine particulate matter to form a filtered decontamination reactor effluent stream. The inlet temperature for the filtration section is typically in the range of 205-315° C. with a pressure of −5 kPa(g) to 50 kPa(g). The outlet temperature for the filtration section is typically in the range of 205-315° C. with a pressure of −7 kPa(g) to 50 kPa(g). After heat recovery from the filtered effluent, the treated flue gas can then be discharged to the atmosphere.

The decontamination reactor effluent stream may be filtered using any suitable filter unit. Suitable filter units include, but are not limited to, a bag filter or an electrostatic precipitator.

Environmental concerns over greenhouse gas emissions have led to an increasing emphasis on separating the greenhouse gases before releasing the flue gases into atmosphere. Carbon dioxide (CO₂) is the most significant long-lived greenhouse gas in earth's atmosphere. CO₂ capture from FCC flue gases is expensive, both from a capital expenditures and operational utility costs (CAPEX and OPEX) standpoint. For fluidized catalytic processes, air is used for regenerating the spent catalyst. As a result of this operation, the amount of CO₂ in the FCC flue gas is lower in contrast to the amount of undesired components from a CO₂ capture perspective. This leads to high capital expenditures due to a large volume of the flue gas. In addition, in solvent-based CO₂ capture processes, it also leads to large OPEX due to high solvent circulating rates and solvent regeneration duties.

The issue of flue gas treatment increases multifold in FCC units operating with partial burn regenerator due to the combustion of CO in a CO Boiler. The CO combustion in CO Boiler requires additional fuel firing (like fuel gas or fuel oil) to maintain a minimum temperature within combustion chamber to ensure complete combustion of CO to CO2. This results in an increase in quantity of CO2 generation by the FCC process and hence an increase in quantity of flue gas to be handled by the CO2 capture process. Also, high temperature operation of the CO Boiler combustion chamber results in additional NOx generation and leading to contamination of the flue gas.

Moreover, the flue gas requires extensive flue gas treatment prior to carbon capture in order to meet stringent specifications to avoid high solvent degradation rates, resulting in high capital expenditures and operational utility costs with required impurity removal operations.

Therefore, there is a need for improved processes for treating flue gas from FCC Unit in particular operating with partial burn regenerators containing CO₂, CO, and sulfur compounds. Also, there is a need for a process and an apparatus which reduces capital expenditures and operational utility costs of the CO2 capture section.

### BRIEF DESCRIPTION OF THE DRAWING

FIG. 1 illustrates one embodiment of a process according to the present invention.

FIG. 2 illustrates another embodiment of a process according to the present invention.

FIG. 3 illustrates another embodiment of a process according to the present invention.

FIG. 4 illustrates another embodiment of the process of FIG. 1.

FIG. 5 illustrates another embodiment of the process of FIG. 2.

FIG. 6 illustrates another embodiment of the process of FIG. 3.

### DESCRIPTION OF THE INVENTION

The process involves processes for separating CO from CO₂ in flue gas streams from partial oxidation regenerator in FCC processes, as well as reducing the sulfur content of the flue gas stream. The processes involve separating the cooled reactor effluent stream into a CO₂ product stream, a CO₂ recycle stream, and a CO product stream. The processes may incorporate either dry sorbent injection (DSI) units or wet gas scrubbing units to remove sulfur compounds.

The separation processes can utilize cryogenic fractionation, pressure swing adsorption (PSA) processes including vacuum PSA (VPSA), and temperature swing adsorption (TSA) processes. The flue gas can be used to preheat the CO₂ recycle stream.

The outlet temperature from the FCC regenerator for a partial combustion FCC unit is about 650-815° C.

In some embodiments, there is a NOx reactor section where nitrogen-containing compounds are reacted. The NOx reactor section may comprise a selective catalytic reduction (SCR) reactor to form a NOx reactor effluent stream with a reduced level of nitrogen-containing compounds compared to the incoming stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NOx reactor section where it reacts with the NOx present in the incoming stream.

In some embodiments, a HRSG is included before the SOx reaction section. The HRSG comprises a superheated steam section and a saturated steam section. In this case, the waste gas stream comprises a flue gas stream, which is introduced into the superheated steam section of the HRSG to produce a superheated steam stream and a partially cooled flue gas stream. A boiler feed water stream and the partially cooled flue gas stream are introduced into the saturated steam section to produce a saturated steam stream and a second partially cooled flue gas stream. All or a portion of the saturated steam stream is introduced into the superheated steam section, where it is superheated with the flue gas stream to produce the superheated steam stream. The second partially cooled flue gas stream is sent to the SOx reaction section.

One aspect of the invention comprises a process for separating CO from CO₂ in a flue gas stream from a partial oxidation regenerator of a fluid catalytic cracking (FCC) process. In one embodiment, the process comprises: passing a mixture of a preheated CO₂ recycle stream and a concentrated oxygen stream to the partial oxidation regenerator to generate the flue gas stream comprising CO₂, CO, SOx, NOx, catalyst fines, O₂, and H₂O; transferring heat from the flue gas stream to a boiler feed water stream in a heat recovery section to form a partially cooled flue gas stream and a steam stream; reacting one or more of a sulfur-containing compound in the flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream; heating a CO₂ recycle stream with the reactor effluent gas stream to produce the preheated CO₂ recycle stream and a cooled reactor effluent stream; and separating the cooled reactor effluent stream into a CO₂ product stream, the CO₂ recycle stream, and a CO product stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; dehydrating the compressed reactor effluent stream to form a dehydrated reactor effluent stream; separating the dehydrated reactor effluent stream into the CO₂ product stream and a CO-containing overhead stream in a cryogenic CO₂ fractionation system; and separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof.

In some embodiments, the process further comprises: compressing or expanding the recycle CO₂ stream before introducing the CO₂ recycle stream into the regenerator.

In some embodiments, the process further comprises: recycling a portion of the CO₂ recycle stream to the compressor.

In some embodiments, the process further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream is the CO₂ recycle stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; separating the compressed reactor effluent stream into a low pressure CO₂-containing stream and a high pressure CO-containing stream in a pressure swing absorption (PSA) unit or a vacuum swing adsorption (VPSA) unit; compressing the low pressure CO₂-containing stream to form a high pressure CO₂-containing stream and an intermediate pressure CO₂-containing stream; co-feeding the intermediate pressure CO₂-containing stream to the PSA or VPSA unit; dehydrating the high pressure CO₂-containing stream to form the CO₂ product stream; purifying the high pressure CO-containing stream in a polishing section to form the CO product stream and wherein a part of the intermediate pressure CO₂-containing stream comprises the CO₂ recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof.

In some embodiments, the process of further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream comprises the CO₂ recycle stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; separating the compressed reactor effluent stream into a CO₂-containing stream and a CO-containing stream in a temperature swing absorption (TSA) unit; compressing the CO₂-containing stream to form the CO₂ product stream; compressing the CO-containing stream to form a high pressure CO stream; dehydrating the high pressure CO-containing stream to form the CO product stream; wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof.

In some embodiments, the process further comprises: dividing the CO-containing stream from the TSA unit into a first part and a second part, wherein the first part is compressed to form the high pressure CO stream; compressing and cooling the second portion of the CO-containing stream and optionally removing water from the cooled, compressed second portion of the CO-containing stream water removal; heating the cooled, compressed second portion of the CO-containing stream to form a heated second portion of the CO-containing stream; introducing the heated second portion of the CO-containing stream to the TSA unit.

In some embodiments, the process further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream; or wherein the compressed portion of the cooled reactor effluent stream comprises the CO₂ recycle stream.

In some embodiments, the process further comprises: further cooling the cooled reactor effluent stream and removing water from the cooled reactor effluent stream before separating the cooled reactor effluent stream.

In some embodiments, the process further comprises: recovering heat from the reactor effluent stream before cooling the reactor effluent stream.

In some embodiments, the process further comprises: introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of the sulfur-containing compound, the nitrogen-containing compound, or both in the flue gas stream with the reactant in the decontamination reactor comprises reacting one or more of the sulfur-containing compound, the nitrogen-containing compound, or both in the partially cooled flue gas stream with the reactant.

In some embodiments, the concentrated oxygen stream is made in an air separation unit or an electrolyzer.

In some embodiments, reacting one or more of the sulfur-containing compound, in the flue gas stream with the reactant in the decontamination reactor comprises: reacting the flue gas stream with a reactant in a dry SOx reaction section to form a dry SOx reaction section flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOx, wherein the reactant comprises at least one of NaHCO₃, NaHCO₃·Na₂CO₃·2(H₂O), CaCO₃, Ca(OH)₂, and Mg(OH)₂; and filtering the dry SOx reaction section flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form the reactor effluent stream and a filtered material stream.

Another aspect of the invention is a process for separating CO from CO₂ in a flue gas stream from a partial oxidation regenerator of a fluid catalytic cracking (FCC) process. In one embodiment, the process comprises: passing a mixture of a preheated CO₂ recycle stream and a concentrated oxygen stream to the partial oxidation regenerator to generate the flue gas stream comprising CO₂, CO, SOx, NOx, catalyst fines, O₂ and H₂O; transferring heat from the flue gas stream to a boiler feed water stream in a heat recovery section to form a partially cooled flue gas stream and a steam stream; heating a CO₂ recycle stream with the partially cooled flue gas stream to produce the preheated CO₂ recycle stream and a cooled flue gas stream; reacting one or more of a sulfur-containing compound, a nitrogen-containing compound, or both in the cooled flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream; and separating the reactor effluent stream into a CO₂ product stream, the CO₂ recycle stream, and a CO product stream; and wherein reacting one or more of the sulfur-containing compound, the nitrogen-containing compound, or both in the cooled flue gas stream with the reactant in the decontamination reactor comprises: reacting a caustic solution or an NH₃ based solution with the cooled flue gas stream in a wet SOx reaction section to form the reactor effluent flue gas stream and a liquid stream comprising at least one of H₂O, CO₂, CO, N₂, O₂, Na₂SO₃, Na₂SO₄, NaHSO₃, Na₂CO₃, (NH₄)₂SO₄, NH₄Cl and catalyst fines.

In some embodiments, the process further comprises cooling the reactor effluent stream before separating the reactor effluent stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; dehydrating the compressed reactor effluent stream to form a dehydrated reactor effluent stream; separating the dehydrated reactor effluent stream into the CO₂ product stream and a CO-containing overhead stream in a cryogenic CO₂ fractionation system; and separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof.

In some embodiments, the process further comprises: compressing or expanding the recycle CO₂ stream before introducing the CO₂ recycle stream into the regenerator.

In some embodiments, the process further comprises: recycling a portion of the CO₂ recycle stream to the compressor.

In some embodiments, the process further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream is the CO₂ recycle stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; separating the compressed reactor effluent stream into a low pressure CO₂-containing stream and a high pressure CO-containing stream in a pressure swing absorption (PSA) unit or a vacuum swing adsorption (VPSA) unit; compressing the low pressure CO₂-containing stream to form a high pressure CO₂-containing stream and an intermediate pressure CO₂-containing stream; co-feeding the intermediate pressure CO₂-containing stream to the PSA or VPSA unit; dehydrating the high pressure CO₂-containing stream to form the CO₂ product stream; purifying the high pressure CO-containing stream in a polishing section to form the CO product stream and wherein a part of the intermediate pressure CO₂-containing stream comprises the CO₂ recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof.

In some embodiments, the process further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream comprises the CO₂ recycle stream.

In some embodiments, separating the reactor effluent stream into the CO₂ product stream, the CO₂ recycle stream, and the CO product stream comprises: compressing the cooled reactor effluent stream in a compressor to form a compressed reactor effluent stream; separating the compressed reactor effluent stream into a CO₂-containing stream and a CO-containing stream in a temperature swing absorption (TSA) unit; compressing the CO₂-containing stream to form the CO₂ product stream; compressing the CO-containing stream to form a high pressure CO stream; dehydrating the high pressure CO-containing stream to form the CO product stream; wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof.

In some embodiments, the process further comprises: dividing the CO-containing stream from the TSA unit into a first part and a second part, wherein the first part is compressed to form the high pressure CO stream; compressing and cooling the second portion of the CO-containing stream and optionally removing water from the cooled, compressed second portion of the CO-containing stream water removal; heating the cooled, compressed second portion of the CO-containing stream to form a heated second portion of the CO-containing stream; introducing the heated second portion of the CO-containing stream to the TSA unit.

In some embodiments, the process further comprises: separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream; or wherein the compressed portion of the cooled reactor effluent stream comprises the CO₂ recycle stream.

In some embodiments, the process further comprises: further cooling the cooled reactor effluent stream and removing water from the cooled reactor effluent stream before separating the cooled reactor effluent stream.

In some embodiments, the process further comprises: recovering heat from the reactor effluent stream before cooling the reactor effluent stream.

In some embodiments, the process further comprises: introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of the sulfur-containing compound, the nitrogen-containing compound, or both in the flue gas stream with the reactant in the decontamination reactor comprises reacting one or more of the sulfur-containing compound, the nitrogen-containing compound, or both in the partially cooled flue gas stream with the reactant.

In some embodiments, the concentrated oxygen stream is made in an air separation unit or an electrolyzer.

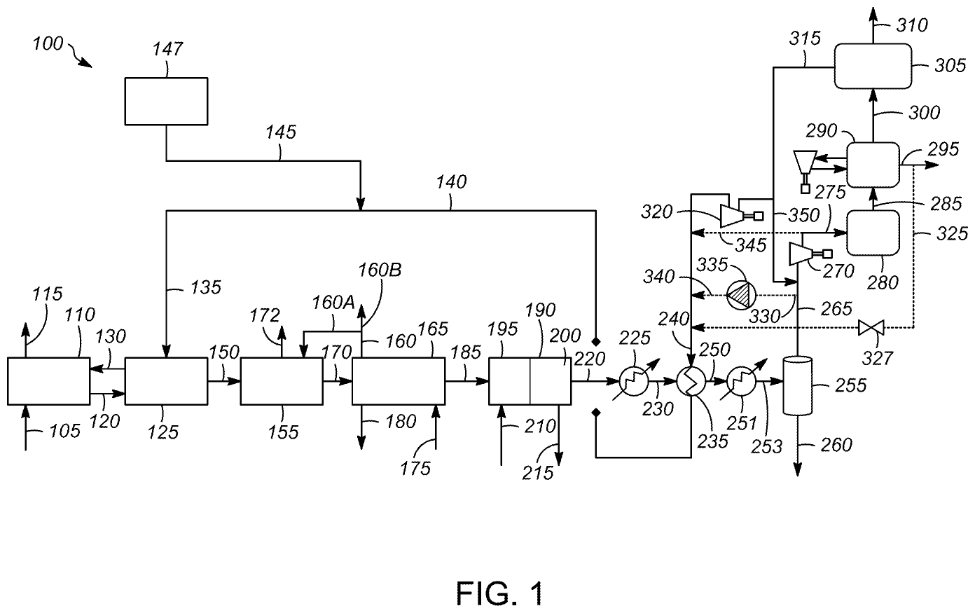

FIG. 1 illustrates one embodiment of the process 100 with a cryogenic CO₂ separation process. The feed stream 105 is sent to the FCC reactor 110 containing catalyst. The product is separated from the catalyst and the product containing stream 115 is sent for further processing.

The spent catalyst stream 120 is sent to the partial combustion regenerator 125 where coke on the catalyst is burned to regenerate the catalyst. The regenerated catalyst 130 is returned to the FCC reactor 110.

A stream 135 containing a mixture of a preheated CO₂ recycle stream 140 and a concentrated oxygen stream 145 is introduced into the partial combustion regenerator 125. The concentrated oxygen stream 145 may be formed in an air separation unit (ASU) or an electrolyser unit 147. The concentrated oxygen stream 145 may have a concentration of 50 mol % oxygen or more, or 60 mol % or more, or 70 mol % or more, or 80 mol % or more, or 90 mol % or more, or 95 mol % or more, or 99 mol % or more, or 99.5 mol % or more, or 99.9 mol % or more.

The partially combusted flue gas stream 150 comprises un-combusted CO, along with CO₂, SOx, NOx, catalyst fines, O₂ and H₂O. The flue gas outlet temperature for the FCC regenerator for a partial combustion FCC is in the range of about 650-815° C.

The partially combusted flue gas stream 150 is sent to the HRSG superheated steam unit 155 where it superheats a portion 160A of the saturated steam stream 160 from the HRSG saturated steam unit 165 forming superheated steam stream 172.

The partially cooled flue gas stream 170 is sent to the HRSG saturated steam unit 165. Boiler feed water stream 175 is heated by the partially cooled flue gas stream 170 forming saturated steam stream 160, condensate stream 180, and a second partially cooled flue gas stream 185. A portion 160A of the saturated steam stream 160 is sent to the HRSG superheated steam unit 155. The remainder 160B of the saturated steam stream 160 can be sent to other parts of the plant for use as needed.

The second partially cooled flue gas stream 185 from the HRSG saturated steam unit 165 is sent to the decontamination reactor 190 which comprises a dry SOx reaction section 195, a filtration section 200. The second partially cooled flue gas stream 185 and the reactant 210 (dry or slurry) are sent to the SOx reaction section where the reactant reacts with the sulfur-containing compounds.

In some embodiments, the NOx compounds are reacted in a NOx reaction section (not shown) before the decontamination reactor 190. The NOx reaction section may comprise a selective catalytic reduction (SCR) reactor to form a NOx reactor effluent stream with a reduced level of nitrogen-containing compounds compared to the incoming stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NOx reactor section where it reacts with the NOx present in the incoming stream. If a NOx reaction section is included, the effluent stream from the NOx reaction section contains a lower level of NOx compounds than the level of NOx compounds in the incoming stream.

The SOx reaction products are filtered out of the dry SOx reaction section flue gas stream in the filtration section 200 forming the filtered material stream 215. The filtration section 200 removes particulate and fines. Electricity is supplied to the filtration section 200 when the filtration section 200 comprises an electrostatic precipitator, and/or instrument air (IA) is supplied to the filtration section 200 comprises a bag filter. The filtered material stream 215 including one or more of Na₂SO₄, NaNO₃, NaNO₂, Na₂CO₃, K₂SO₄, and KNO₃, and catalyst fines is removed from the filtration section 200. The filtered material stream 215 can be removed from process. Alternatively, or additionally, the filtered material stream 215 can be recycled to the decontamination reactor 190 to increase the Na₂CO₃ conversion yield (i.e., from 85 wt % to 98 wt %).

The reactor effluent stream 220 from the decontamination reactor 190 contains a lower level of SOx compounds than the level of SOx compounds in the incoming second partially cooled flue gas stream 185 from the HRSG saturated steam unit 165.

The reactor effluent stream 220 may optionally be sent to a heat exchanger 225 to recover heat.

The reactor effluent stream 220 (or reactor effluent stream 230 if the optional heat exchanger 225 is present) is sent to heat exchanger 235 where it is heat exchanged with CO₂ recycle stream 240 to form the preheated CO₂ recycle stream 140 and a cooled reactor effluent stream 250.

The cooled reactor effluent stream 250 may be sent to an optional heat exchanger 251 to further cool and condense it forming cooled reactor effluent stream 253.

The cooled reactor effluent stream 250 (or 253) is separated into a CO₂ product stream, the CO₂ recycle stream 140, and a CO product stream.

In FIG. 1, the cooled reactor effluent stream 253 (or 250) is sent to a knock-out drum 255 to remove a water stream 260. The overhead cooled reactor effluent stream 265 is compressed in compressor 270 forming a compressed reactor effluent stream 275 which is sent to dehydrator 280. The dehydrated reactor effluent stream 285 is sent to a cryogenic CO₂ fractionation system 290 where it is separated into a CO₂ product stream 295 and a CO-containing overhead stream 300.

The CO-containing overhead stream 300 may be sent to a separation section 305 where it is separated into CO product stream 310 and CO₂ recycle stream 315.

The CO₂ recycle stream 315 may be compressed or expanded in compressor or expander 320 forming the CO₂ recycle stream 240 before being heat exchanged with the reactor effluent stream 220 (or 230) if needed. The CO₂ recycle stream 240 may comprise all or a portion of the CO₂ recycle stream 315.

Alternatively, the separation section 305 may be omitted. In this case, the CO-containing overhead stream 300 is the CO product stream. All or a portion of the CO₂ recycle stream 240 may be a portion 325 of the CO₂ product stream 295.

In another alternative, a portion 330 of the overhead cooled reactor effluent stream 265 may be compressed in a compressor 335 to form a compressed stream 340. All or a portion of the CO₂ recycle stream 240 may be the compressed stream 340.

In another alternative, all or a portion of the CO₂ recycle stream 240 may be a portion 345 of the compressed reactor effluent stream 275.

A portion 350 of the CO₂ recycle stream 315 may be recycled to the compressor 270.

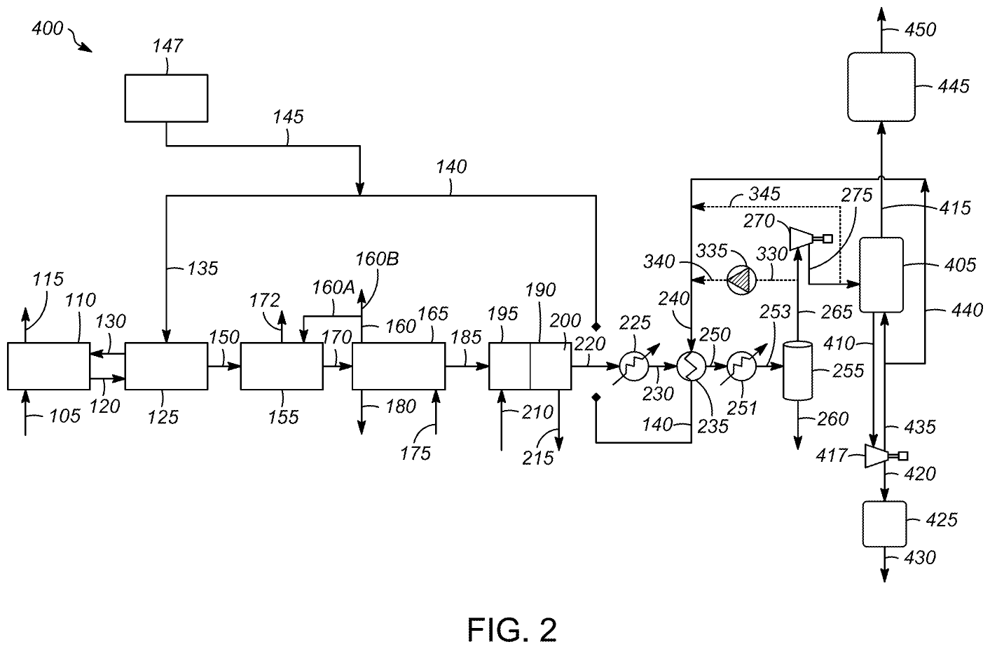

FIG. 2 illustrates one embodiment of the process 400 including a PSA separation process. The feed stream 105 is sent to the FCC reactor 110 containing catalyst. The product is separated from the catalyst and the product containing stream 115 is sent for further processing.

The spent catalyst stream 120 is sent to the partial combustion regenerator 125 where coke on the catalyst is burned to regenerate the catalyst. The regenerated catalyst 130 is returned to the FCC reactor 110.

A stream 135 containing a mixture of a preheated CO₂ recycle stream 140 and a concentrated oxygen stream 145 is introduced into the partial combustion regenerator 125. The concentrated oxygen stream 145 may be formed in an Air Separation Unit (ASU) unit or an electrolyser unit 147.

The partially combusted flue gas stream 150 comprises un-combusted CO, along with CO₂, SOx, NOx, catalyst fines, O₂ and H₂O. The flue gas outlet temperature for the FCC regenerator for a partial combustion FCC is in the range of about 650-815° C.

The partially combusted flue gas stream 150 is sent to the HRSG superheated steam unit 155 where it superheats a portion 160A of the saturated steam stream 160 from the HRSG saturated steam unit 165 forming superheated steam stream 172.

The partially cooled flue gas stream 170 is sent to the HRSG saturated steam unit 165. Boiler feed water stream 175 is heated by the partially cooled flue gas stream 170 forming saturated steam stream 160, condensate stream 180, and a second partially cooled flue gas stream 185. A portion 160A of the saturated steam stream 160 is sent to the HRSG superheated steam unit 155. The remainder 160B of the saturated steam stream 160 can be sent to other parts of the plant for use as needed.

The second partially cooled flue gas stream 185 from the HRSG saturated steam unit 165 is sent to the decontamination reactor 190 which comprises a dry SOx reaction section 195, a filtration section 200. The second partially cooled flue gas stream 185 and the reactant 210 (dry or slurry) are sent to the SOx reaction section where the reactant reacts with the sulfur-containing compounds.

In some embodiments, the NOx compounds are reacted in a NOx reaction section (not shown) before the decontamination reactor 190. The NOx reaction section may comprise a selective catalytic reduction (SCR) reactor to form a NOx reactor effluent stream with a reduced level of nitrogen-containing compounds compared to the incoming stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NOx reactor section where it reacts with the NOx present in the incoming stream. If a NOx reaction section is included, the effluent stream from the NOx reaction section contains a lower level of NOx compounds than the level of NOx compounds in the incoming stream.

The SOx reaction products are filtered out of the dry SOx reaction section flue gas stream in the filtration section 200 forming the filtered material stream 215. The filtration section 200 removes particulate and fines. Electricity is supplied to the filtration section 200 when the filtration section 200 comprises an electrostatic precipitator, and/or IA is supplied to the filtration section 200 comprises a bag filter. The filtered material stream 215 including one or more of Na₂SO₄, NaNO₃, NaNO₂, Na₂CO₃, K₂SO₄, and KNO₃, and catalyst fines is removed from the filtration section 200. The filtered material stream 215 can be removed from process. Alternatively, or additionally, the filtered material stream 215 can be recycled to the decontamination reactor 190 to increase the Na₂CO₃ conversion yield (i.e., from 85 wt % to 98 wt %).

The reactor effluent stream 220 from the decontamination reactor 190 contains a lower level of SOx compounds than the level of SOx compounds in the incoming second partially cooled flue gas stream 185 from the HRSG saturated steam unit 165.

The reactor effluent stream 220 may optionally be sent to a heat exchanger 225 to recover heat.

The reactor effluent stream 220 (or reactor effluent stream 230 if the optional heat exchanger 225 is present) is sent to heat exchanger 235 where it is heat exchanged with CO₂ recycle stream 240 to form the preheated CO₂ recycle stream 140 and a cooled reactor effluent stream 250.

The cooled reactor effluent stream 250 may be sent to an optional heat exchanger 251 to further cool and condense it forming cooled reactor effluent stream 253.

The cooled reactor effluent stream 250 (or 253) is separated into a CO₂ product stream, the CO₂ recycle stream 140, and a CO product stream.

In FIG. 2, the cooled reactor effluent stream 250 is sent to a knock-out drum 255 to remove a water stream 260. The overhead cooled reactor effluent stream 265 is compressed in compressor 270 forming a compressed reactor effluent stream 275 which is sent to PSA unit 405 where it is separated into a low-pressure CO₂-containing stream 410 and a high pressure CO-containing overhead stream 415.

The low-pressure CO₂-containing stream 410 is compressed in compressor 417 to form a high pressure CO₂-containing stream 420. The high pressure CO₂-containing stream 420 is sent to dehydrator 425 forming a dehydrated high pressure CO₂-containing stream 430 which is the CO₂ product stream.

An intermediate pressure CO₂-containing stream 435 is also formed in the compressor 417 from the low-pressure CO₂-containing stream 410. The intermediate pressure CO₂-containing stream 435 is co-fed to the PSA unit 405.

A portion 440 of the intermediate pressure CO₂-containing stream 435 may comprise all or a portion of the CO₂ recycle stream 240.

The high pressure CO-containing overhead stream 415 may be sent to a polishing section 445 to purify the high pressure CO-containing overhead stream 415 to form CO product stream 450.

The CO₂ recycle stream 440 may be expanded in an expander or a pressure valve (not shown) to reduce the pressure in the CO₂ recycle stream 440 before being heat exchanged with the reactor effluent stream 220 (or 230) if needed. The CO₂ recycle stream 240 may comprise all or a portion of the CO₂ recycle stream 440.

Alternatively, the polishing section 445 may be omitted. In this case, the high pressure CO-containing overhead stream 415 is the CO product stream.

In another alternative, a portion 330 of the overhead cooled reactor effluent stream 265 may be compressed to form a compressed stream 340. All or a portion of the CO₂ recycle stream 240 may be the compressed stream 340.

In another alternative, all or a portion of the CO₂ recycle stream 240 may be a portion 345 of the compressed reactor effluent stream 275.

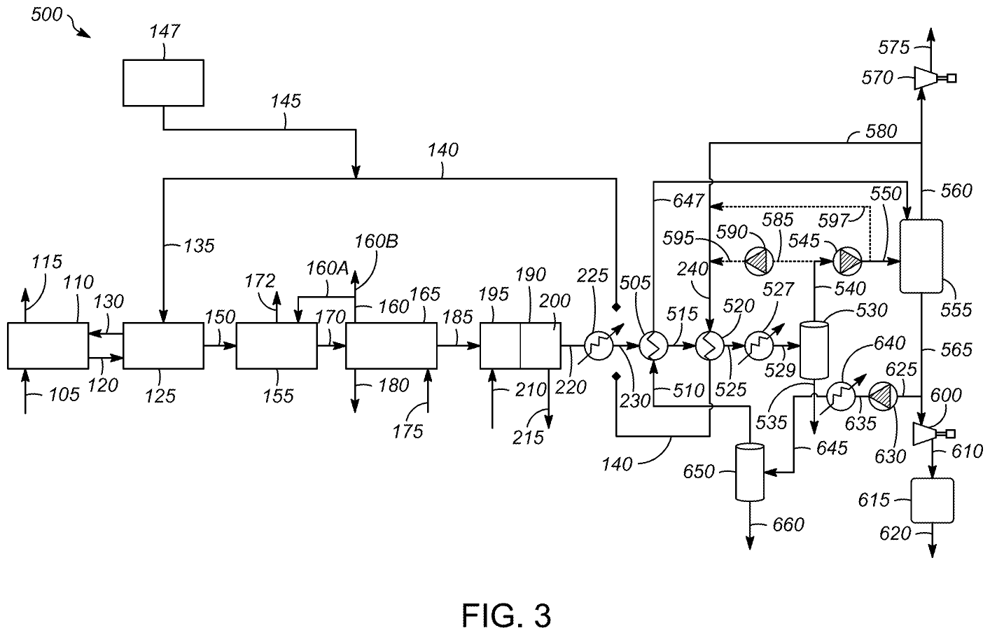

FIG. 3 illustrates one embodiment of the process 500 with a TSA separation process. The feed stream 105 is sent to the FCC reactor 110 containing catalyst. The product is separated from the catalyst and the product containing stream 115 is sent for further processing.

The spent catalyst stream 120 is sent to the partial combustion regenerator 125 where coke on the catalyst is burned to regenerate the catalyst. The regenerated catalyst 130 is returned to the FCC reactor 110.

A stream 135 containing a mixture of a preheated CO₂ recycle stream 140 and a concentrated oxygen stream 145 is introduced into the partial combustion regenerator 125. The concentrated oxygen stream 145 may be formed in an Air Separation Unit (ASU) unit or an electrolyser unit 147.

The partially combusted flue gas stream 150 comprises un-combusted CO, along with CO₂, SOx, NOx, catalyst fines, O₂ and H₂O. The flue gas outlet temperature for the FCC regenerator for a partial combustion FCC is in the range of about 650-815° C.

The partially combusted flue gas stream 150 is sent to the HRSG superheated steam unit 155 where it superheats a portion 160A of the saturated steam stream 160 from the HRSG saturated steam unit 165 forming superheated steam stream 172.

The partially cooled flue gas stream 170 is sent to the HRSG saturated steam unit 165. Boiler feed water stream 175 is heated by the partially cooled flue gas stream 172 forming saturated steam stream 160, condensate stream 180, and a second partially cooled flue gas stream 185. A portion 160A of the saturated steam stream 160 is sent to the HRSG superheated steam unit 155. The remainder 160B of the saturated steam stream 160 can be sent to other parts of the plant for use as needed.

The second partially cooled flue gas stream 185 from the HRSG saturated steam unit 165 is sent to the decontamination reactor 190 which comprises a dry SOx reaction section 195, a filtration section 200. The second partially cooled flue gas stream 185 and the reactant 210 (dry or slurry) are sent to the SOx reaction section where the reactant reacts with the sulfur-containing compounds.

In some embodiments, the NOx compounds are reacted in a NOx reaction section (not shown) before the decontamination reactor 190. The NOx reaction section may comprise a selective catalytic reduction (SCR) reactor to form a NOx reactor effluent stream with a reduced level of nitrogen-containing compounds compared to the incoming stream. Any suitable SCR catalyst could be used, including but not limited to, ceramic carrier materials such as titanium oxide with active catalytic components such as oxides of base metals including TiO₂, WO₃ and V₂O₅, or an activated carbon-based catalyst. An ammonia and/or urea stream is introduced into the NOx reactor section where it reacts with the NOx present in the incoming stream. If a NOx reaction section is included, the effluent stream from the NOx reaction section contains a lower level of NOx compounds than the level of NOx compounds in the incoming stream.

The SOx reaction products are filtered out of the dry SOx reaction section flue gas stream in the filtration section 200 forming the filtered material stream 215. The filtration section 200 removes particulate and fines. Electricity is supplied to the filtration section 200 when the filtration section 200 comprises an electrostatic precipitator, and/or IA is supplied to the filtration section 200 comprises a bag filter. The filtered material stream 215 including one or more of Na₂SO₄, NaNO₃, NaNO₂, Na₂CO₃, K₂SO₄, and KNO₃, and catalyst fines is removed from the filtration section 200. The filtered material stream 215 can be removed from process. Alternatively, or additionally, the filtered material stream 215 can be recycled to the decontamination reactor 190 to increase the Na₂CO₃ conversion yield (i.e., from 85 wt % to 98 wt %).

The reactor effluent stream 220 from the decontamination reactor 190 contains a lower level of SOx compounds than the level of SOx compounds in the incoming second partially cooled flue gas stream 185 from the HRSG saturated steam unit 165.

The reactor effluent stream 220 may optionally be sent to a heat exchanger 225 to recover heat.

The reactor effluent stream 220 (or reactor effluent stream 230 if the optional heat exchanger 225 is present) is sent to heat exchanger 505 where it is heat exchanged with stream 510.

The cooled reactor effluent stream 515 is sent to heat exchanger 520 where it is heat exchanged with CO₂ recycle stream 240 to form the preheated CO₂ recycle stream 140 and a second cooled reactor effluent stream 525.

The second cooled reactor effluent stream 525 may be sent to optional heat exchanger 527 where it is cooled and condensed forming stream 529.

The second cooled reactor effluent stream 525 (or stream 529) is separated into a CO₂ product stream, the CO₂ recycle stream 240, and a CO product stream.

In FIG. 3, the second cooled reactor effluent stream 525 is sent to a knock-out drum 530 to remove a water stream 535. The overhead cooled reactor effluent stream 540 is compressed in compressor 545 forming a compressed reactor effluent stream 550 which is sent to TSA unit 555 where it is separated into a CO₂-containing stream 560 and a CO-containing stream 565.

The CO₂-containing stream 560 is sent to a compressor 570 forming CO₂ product stream 575.

A portion 580 of the CO₂-containing stream 560 forms the CO₂ recycle stream 240 which heat exchanged with the cooled reactor effluent stream 515. The portion 580 can optionally be expanded and heat exchanged before being heat exchanged with the cooled reactor effluent stream 515 (not shown). The portion 580 of the CO₂-containing stream 560 may comprise all or a portion of the CO₂ recycle stream 240.

Alternatively, a portion 585 of the overhead cooled reactor effluent stream 540 may be compressed in a compressor 590 to form a compressed stream 595. The compressed stream 595 may comprise all or a portion of the CO₂ recycle stream 240 or it may be combined with the preheated CO₂ recycle stream 140.

Alternatively, a portion 597 of the compressed stream 550 may comprise all or a portion of the CO₂ recycle stream 240 or it may be combined with the preheated CO₂ recycle stream 140.

The CO-containing stream 565 is sent to compressor 600 forming high pressure CO stream 610. The high-pressure CO stream 610 is sent to dehydrator 615 forming the CO product stream 620.

A portion 625 of the CO-containing stream 565 is compressed in compressor 630 forming compressed CO-containing stream 635. The compressed CO-containing stream 635 is sent to heat exchanger 640 forming cooled CO-containing stream 645. The cooled CO-containing stream 645 is sent to knockout drum 650 to form water stream 660 and stream 510.

Stream 510 is heat exchanged with the reactor effluent stream 220 (or 230) in heat exchanger 505 to form heated CO-containing stream 647. The heated CO-containing stream 647 is recycled to the TSA unit 555 for regeneration.

In another alternative, all or a portion of the CO₂ recycle stream 240 may be a portion 597 of the compressed reactor effluent stream 550.

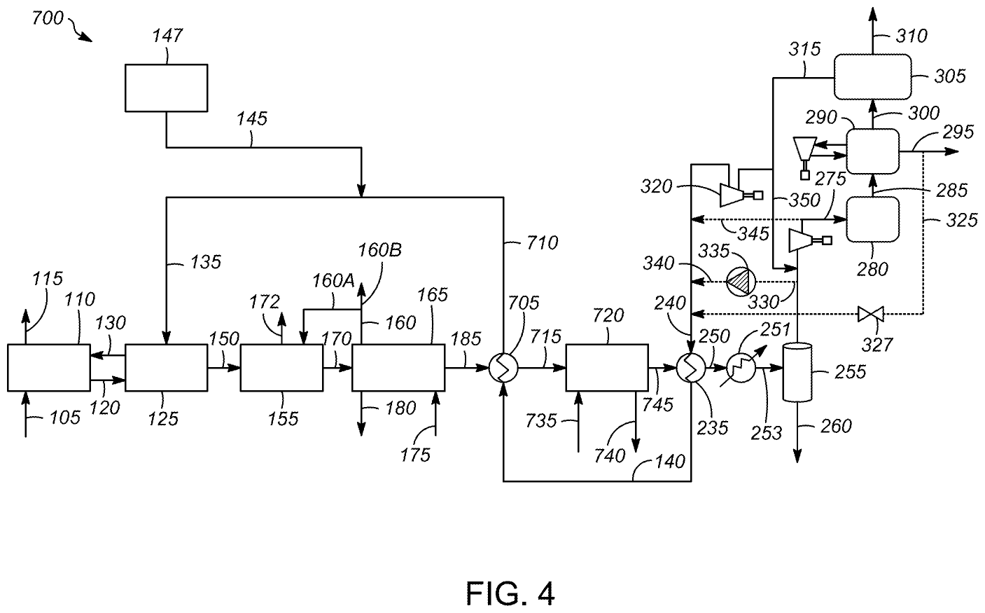

FIG. 4 illustrates an embodiment including the cryogenic CO₂ separation process 400 and incorporating a wet scrubbing process. In this case, the second partially cooled flue gas stream 185 from the HRSG saturated steam unit 165 is used to further pre-heat preheated CO₂ recycle stream 140 in heat exchanger 705, forming a second preheated CO₂ recycle stream 710 which is combined with the concentrated oxygen stream 145 and sent to the partial combustion regenerator 125.

In some embodiments, the NOx compounds are reacted in a NOx reaction section as described above.

The third partially cooled flue gas stream 715 is sent to the decontamination reactor 720 which comprises a wet SOx reaction section. A stream 735 comprising a caustic solution or an NH₃ based solution reacts with the SOx compounds in the third partially cooled flue gas stream 715 in the wet SOx reaction section to form a SOx reactor effluent stream and a liquid stream 740 comprising at least one of H₂O, Na₂SO₃, Na₂SO₄, NaHSO₃, Na₂CO₃, (NH₄)₂SO₄ and catalyst fines.

The reactor effluent stream 745 from the decontamination reactor 720 contains a lower level of SOx compounds than the level of SOx compounds in the incoming third partially cooled flue gas stream 715.

The reactor effluent stream 745 from the decontamination reactor 720 is sent to heat exchanger 235 and the process continues as described above in FIG. 1.

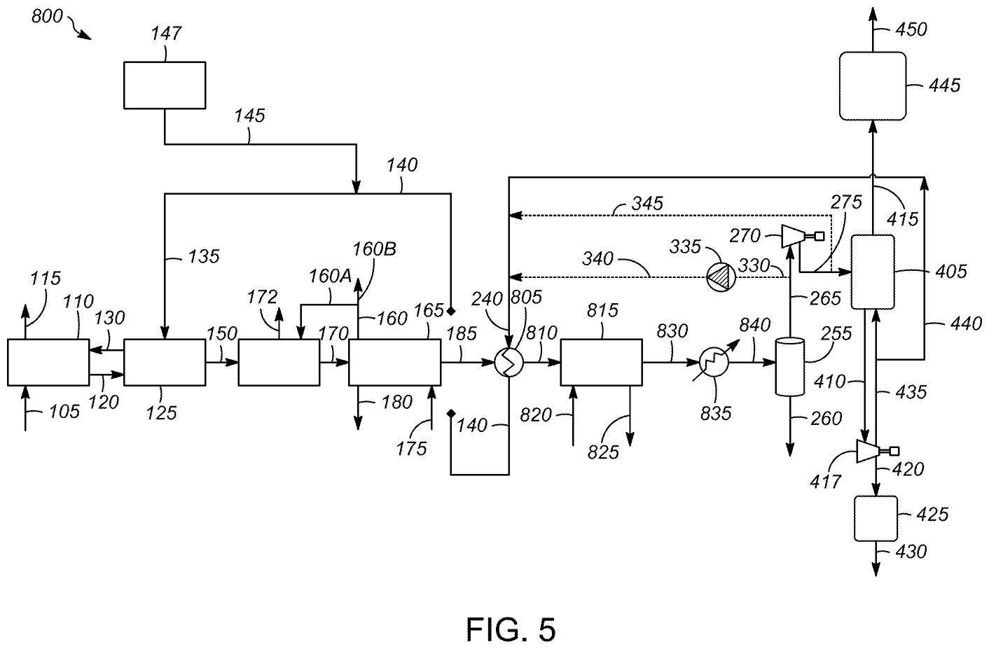

FIG. 5 illustrates an embodiment of the PSA separation process 800 incorporating a wet scrubbing process. In this case, the second partially cooled flue gas stream 185 from the HRSG saturated steam unit 165 is used to pre-heat CO₂ recycle stream 240 in heat exchanger 805, forming a preheated CO₂ recycle stream 140 which is combined with the concentrated oxygen stream 145 and sent to the partial combustion regenerator 125.

In some embodiments, the NOx compounds are reacted in a NOx reaction section as described above.

The fourth partially cooled flue gas stream 810 is sent to the decontamination reactor 815 which comprises a wet SOx reaction section. A stream 820 comprising a caustic solution or an NH₃ based solution reacts with the SOx compounds in the fourth partially cooled flue gas stream 810 in the wet SOx reaction section to form a liquid stream 825 comprising at least one of H₂O, Na₂SO₃, Na₂SO₄, NaHSO₃, Na₂CO₃, (NH₄)₂SO₄ and catalyst fines.

The reactor effluent stream 830 from the decontamination reactor 815 contains a lower level of SOx compounds than the level of SOx compounds in the incoming fourth partially cooled flue gas stream 810.

The reactor effluent stream 830 is passed through optional heat exchanger 835 forming the cooled reactor effluent stream 840 which is sent to knock-out drum 255. The rest of the process is as described with respect to FIG. 2.

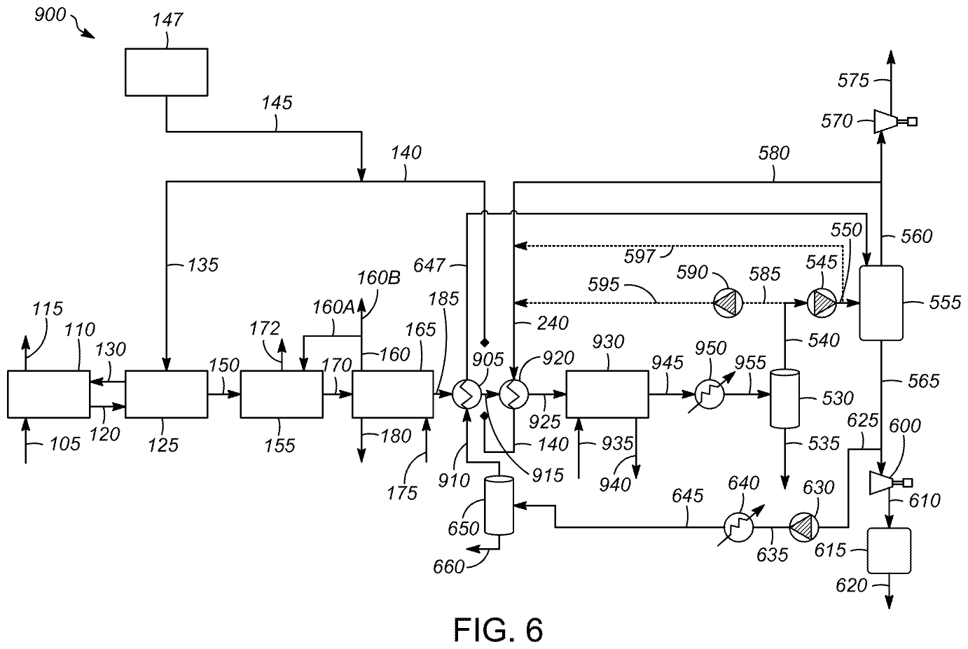

FIG. 6 illustrates an embodiment including the TSA separation process 900 and incorporating a wet scrubbing process. In this case, the second partially cooled flue gas stream 185 from the HRSG saturated steam unit 165 heats stream 910 in heat exchanger 905. The third partially cooled stream 915 is used to pre-heat CO₂ recycle stream 240 in heat exchanger 920 forming the preheated CO₂ recycle stream 140 which is combined with the concentrated oxygen stream 145 and sent to the partial combustion regenerator 125.

In some embodiments, the NOx compounds are reacted in a NOx reaction section as described above.

The fourth partially cooled flue gas stream 925 is sent to the decontamination reactor 930 which comprises a wet SOx reaction section. A stream 935 comprising a caustic solution or an NH₃ based solution reacts with the SOx compounds in the fourth partially cooled flue gas stream 925 in the wet SOx reaction section to form a liquid stream 940 comprising at least one of H₂O, Na₂SO₃, Na₂SO₄, NaHSO₃, Na₂CO₃, (NH₄)₂SO₄ and catalyst fines.

The reactor effluent stream 945 from the decontamination reactor 930 contains a lower level of SOx compounds than the level of SOx compounds in the incoming fourth partially cooled flue gas stream 925.

The reactor effluent stream 945 from the decontamination reactor 930 is sent to heat exchanger 950, and the fifth cooled reactor effluent stream 955 is sent to the knock-out drum 530. The process then continues as described above with respect to FIG. 3.

### EXAMPLES

### FCC Oxyfuel Combustion CO Valorization Example

Several examples for FCC oxyfuel combustion have been evaluated for this case, each with the same combustion and NOx/SOx removal technology and heat integration. The partial combustion regenerator (125) is operated in partial combustion mode and is followed by a HRSG superheated steam unit (155) and HRSG saturated steam unit (165). The stream then goes to a decontamination reactor (190) to remove contaminants such as SOx and NOx. SOx removal in this example is achieved via dry-sorbent injection. This is true in all the examples below.

Alternatively, the decontamination reactor (720) can contain a wet SOₓ reaction section, which slightly changes the location of the heat exchanger noted below, but does not change the CO₂ separation system (305), PSA system (405), or TSA (555). An example is not shown for this scheme, as it only slightly alters the heat recovery network.

The decontamination reactor (190) is followed by heat recovery in a process-process heat exchanger (235) and a KO drum (255). All examples below involve recycling CO₂ upstream of the CO₂ separation system (305), PSA system (405), or TSA (555)—collectively referred to as the CO₂ capture system in this example section. The key difference in each example is the CO₂ capture system utilized. Each example follows similar process steps outlined above.

All examples utilize CO₂ product recycle. Not shown in the examples is the ability to recycle from a stream other than the CO₂ product stream to the regenerator. For the cryogenic solutions (Examples 1 and 2, as shown in FIGS. 1 and 2), this would involve recycle from streams such as Streams 330/340, Stream 345, and the difference of streams 350 and 315.

This holds true for the similar streams in the PSA and TSA examples as well. The selected examples involve high purity CO₂ recycle, but the same recycle concept can be applied to these alternate streams. The selection of which stream to recycle CO₂ from is typically based on overall economics and operability of the combined system.

### Example 1

An example case was developed for the cryogenic fractionation separation technology only separation case. Key material balances from streams up to the CO₂ capture system can be found in Table 1. Temperatures, pressures, and overall mass flow rate for the section upstream of the CO₂ capture system can vary depending on upstream FCC unit operation and the specific composition of the CO₂ recycle stream from the downstream CO₂ separation unit.

TABLE 1
Typical Example of Key Stream Information Upstream of
CO₂ Capture System for Cryogenic Fractionation Only Separation

| | | Stream # | | | | | |
|---|---|---|---|---|---|---|---|
| | Units | 145 | 135 | 150 | 185 | 220 | 253 |
| Stream | | Concentrated | Mixture of | Partially | Cooled | Reactor | Cooled |
| Description | | O₂ | Preheated CO₂ | Combusted | Flue Gas | Effluent | Reactor |
| | | | Recycle and | Flue Gas | Stream | | Effluent |
| | | | Concentrated O₂ | | | | |
| Temperature | ° F. | 90 | 291 | 1317 | 450 | 450 | 120 |
| Pressure | psig | 50 | 32 | 19 | 3 | 2 | 0.25 |
| Molar Flow | lbmol/ | 3827 | 20100 | 21418 | 21418 | 21404 | 21404 |
| | hr | | | | | | |
| Mass Flow | lb/hr | 122380 | 838559 | 883157 | 883157 | 882233 | 882233 |
| Composition | mol % | | | | | | |
| H₂O | | 0 | 0 | 8.3 | 8.3 | 8.3 | 8.3 |
| O₂ | | 99.5 | 18.9 | 0.2 | 0.2 | 0.2 | 0.2 |
| N₂ | | 0.5 | 0.1 | 0.1 | 0.1 | 0.1 | 0.1 |
| CO | | 0 | 0 | 3.7 | 3.7 | 3.7 | 3.7 |
| CO₂ | | 0 | 81.0 | 87.6 | 87.6 | 87.7 | 87.7 |
| SO₂ | | 0 | Trace | <1000 ppm | <1000 ppm | <10 ppm | <10 ppm |
| SO₃ | | 0 | Trace | <1000 ppm | <1000 ppm | <10 ppm | <10 ppm |
| NO | | 0 | Trace | <1000 ppm | <1000 ppm | <10 ppm | <10 ppm |
| NO₂ | | 0 | Trace | <1000 ppm | <1000 ppm | <10 ppm | <10 ppm |

The CO and CO₂ product stream material balances can be seen in Table 2. The cryogenic only solution can allow for the highest CO₂ purity, typically 99+ mol % CO₂, while generating a CO stream that is typically 65 mol % or greater CO. Temperatures and pressures of the CO₂ fractionation system can be set to target the required CO₂ purity, which result in a secondary stream concentrated in CO.

TABLE 2
Typical Example of Key Stream Information
for Cryogenic Fractionation Only Separation

| | | Stream # | | | | | |
|---|---|---|---|---|---|---|---|
| | | | Difference of | | | | |
| | Units | 275 | 295 & 325 | | 300 | 325 | |
| Stream | | Compressed | CO₂ Product | | CO Containing | CO₂ Product | |
| Description | | Reactor Effluent | Stream | | Overhead | Recycle | |
| Temperature | ° F. | 158 | 82 | | 77 | 120 | |
| Pressure | psig | 603 | 980 | | 5 | 50 | |
| Molar Flow | lbmol/hr | 19735 | 2503 | | 1081 | 16273 | |
| Mass Flow | lb/hr | 852080 | 110136 | | 34131 | 716178 | |
| Composition | mol % | | | | | | |
| H₂O | | 0.6 | 0 | | 0 | 0 | |
| O₂ | | 0.2 | 5 | ppm | 4.4 | 5 | ppm |
| N₂ | | 0.1 | 0 | | 1.8 | 0 | |
| CO | | 4.0 | 10 | ppm | 72.7 | 10 | ppm |
| CO₂ | | 95.1 | 99.9+ | | 21.1 | 99.9+ | |
| SO₂ | | <10 ppm | <10 | ppm | 0 | <10 | ppm |
| SO₃ | | <10 ppm | <10 | ppm | 0 | <10 | ppm |
| NO | | <10 ppm | 0 | | <50 ppm | 0 | |
| NO₂ | | <10 ppm | <10 | ppm | 0 | <10 | ppm |

### Example 2

An example case was developed for the cryogenic separation case followed by an additional CO purification step. The required CO purity dictates the technology type/s that is/are selected for this additional purification step. In this example, the additional CO purification step is a pressure swing adsorption (PSA) unit. Key material balances from streams up to the CO₂ capture system can be found in Table 3. Temperatures, pressures, and overall mass flow rate for the section upstream of the CO₂ capture system can vary depending on upstream FCC unit operation and the specific composition of the CO₂ recycle stream from the downstream CO₂ separation unit.

TABLE 3
Typical Example of Key Stream Information Upstream of CO₂ Capture System for Cryogenic
Fractionation with Additional Pressure Swing Adsorption (PSA) Separation

| | | Stream # | | | | | |
|---|---|---|---|---|---|---|---|
| | Units | 145 | 135 | 150 | 185 | 220 | 253 |
| Stream | | Concentrated | Mixture of | Partially | Cooled | Reactor | Cooled |
| Description | | O₂ | Preheated CO₂ | Combusted | Flue Gas | Effluent | Reactor |
| | | | Recycle and | Flue Gas | Stream | | Effluent |
| | | | Concentrated O₂ | | | | |
| Temperature | ° F. | 90 | 291 | 1317 | 450 | 450 | 120 |
| Pressure | psig | 50 | 32 | 19 | 3 | 2 | 0.25 |
| Molar Flow | lbmol/ | 3827 | 17979 | 19296 | 19296 | 19281 | 19281 |
| | hr | | | | | | |
| Mass Flow | lb/hr | 122380 | 745189 | 789802 | 789802 | 788846 | 788846 |
| Composition | mol % | | | | | | |
| H₂O | | 0 | 0 | 9.2 | 9.2 | 9.2 | 9.2 |
| O₂ | | 99.5 | 21.2 | 0.2 | 0.2 | 0.2 | 0.2 |
| N₂ | | 0.5 | 0.1 | 0.1 | 0.1 | 0.1 | 0.1 |
| CO | | 0 | 0 | 4.1 | 4.1 | 4.1 | 4.1 |
| CO₂ | | 0 | 78.7 | 86.3 | 86.3 | 86.4 | 86.4 |
| SO₂ | | 0 | Trace | <1000 ppm | <1000 ppm | <10 ppm | <10 ppm |
| SO₃ | | 0 | Trace | <1000 ppm | <1000 ppm | <10 ppm | <10 ppm |
| NO | | 0 | Trace | <1000 ppm | <1000 ppm | <10 ppm | <10 ppm |
| NO₂ | | 0 | Trace | <1000 ppm | <1000 ppm | <10 ppm | <10 ppm |

The CO and CO₂ product stream material balances can be seen in Table 4. This example case maintains the high CO₂ purity from the previous example with the same temperature and pressure requirements, while increasing CO product purity typically to higher than 80 mol %.

TABLE 4
Typical Example of Key Stream Information for Cryogenic Fractionation
with Additional Pressure Swing Adsorption (PSA) Separation

| | | Stream # | | | | |
|---|---|---|---|---|---|---|
| | | | Difference of | | | |
| | Units | 275 | 295 & 325 | 310 | 325 | 315 |
| Stream | | Compressed | CO₂ Product | CO | CO₂ Product | CO₂ Recycle |
| Description | | Reactor Effluent | | Product | Recycle | |
| Temperature | ° F. | 158 | 82 | 85 | 120 | 65 |
| Pressure | psig | 603 | 980 | 185 | 50 | 5 |
| Molar Flow | lbmol/hr | 18003 | 2497 | 785 | 14147 | 399 |
| Mass Flow | lb/hr | 773971 | 109870 | 22052 | 622594 | 15417 |
| Composition | mol % | | | | | |
| H₂O | | 0.6 | 0 | 0 | 0 | 0 |
| O₂ | | 0.3 | 5 ppm | 5.5 | 5 ppm | 3.0 |
| N₂ | | 0.1 | 0 | 2.2 | 0 | 0.5 |
| CO | | 5.0 | 10 ppm | 92.0 | 10 ppm | 30.7 |
| CO₂ | | 93.9 | 99.9+ | 0.2 | 99.9+ | 66.8 |
| SO₂ | | <10 ppm | <10 ppm | 0 | <10 ppm | <10 ppm |
| SO₃ | | <10 ppm | <10 ppm | 0 | <10 ppm | <10 ppm |
| NO | | <10 ppm | 0 | <50 ppm | 0 | <10 ppm |
| NO₂ | | <10 ppm | <10 ppm | 0 | <10 ppm | <10 ppm |

### Example 3

An example case was developed for the pressure swing adsorption (PSA) only separation case. Key material balances from streams up to the CO₂ capture system can be found in Table 5. Temperatures, pressures, and overall mass flow rate for the section upstream of the CO₂ capture system can vary depending on upstream FCC unit operation and the specific composition of the CO₂ recycle stream from the downstream CO₂ separation unit.

TABLE 5
Typical Example of Key Stream Information Upstream of CO₂ Capture
System for Pressure Swing Adsorption (PSA) Only Separation

| | | Stream # | | | | | |
|---|---|---|---|---|---|---|---|
| | Units | 145 | 135 | 150 | 185 | 220 | 253 |
| Stream | | Concentrated | Mixture of | Partially | Cooled | Reactor | Cooled |
| Description | | O₂ | Preheated CO₂ | Combusted | Flue Gas | Effluent | Reactor |
| | | | Recycle and | Flue Gas | Stream | | Effluent |
| | | | Concentrated O₂ | | | | |
| Temperature | ° F. | 90 | 291 | 1317 | 450 | 450 | 120 |
| Pressure | psig | 50 | 32 | 19 | 3 | 2 | 0.25 |
| Molar Flow | lbmol/ | 3819 | 18537 | 19854 | 19854 | 19840 | 19840 |
| | hr | | | | | | |
| Mass Flow | lb/hr | 122124 | 768194 | 812807 | 812807 | 811866 | 811866 |
| Composition | mol % | | | | | | |
| H₂O | | 0 | 0 | 9.0 | 9.0 | 9.0 | 9.0 |
| O₂ | | 99.5 | 20.5 | 0.2 | 0.2 | 0.2 | 0.2 |
| N₂ | | 0.5 | 0.1 | 0.1 | 0.1 | 0.1 | 0.1 |
| CO | | 0 | 0.5 | 4.4 | 4.4 | 4.5 | 4.5 |
| CO₂ | | 0 | 78.8 | 86.2 | 86.2 | 86.2 | 86.2 |
| SO₂ | | 0 | Trace | <1000 ppm | <1000 ppm | <10 ppm | <10 ppm |
| SO₃ | | 0 | Trace | <1000 ppm | <1000 ppm | <10 ppm | <10 ppm |
| NO | | 0 | Trace | <1000 ppm | <1000 ppm | <10 ppm | <10 ppm |
| NO₂ | | 0 | Trace | <1000 ppm | <1000 ppm | <10 ppm | <10 ppm |

The CO and CO₂ product stream material balances can be seen in Table 6. The PSA only case can achieve CO₂ concentration typically between 97-99.5% with a slight increase in CO concentration, as shown in the example below. Alternatively, the PSA only case can sacrifice CO₂ purity for additional CO concentration in the overhead stream, allowing for flexibility of overall design and operation to meet a specific need.

TABLE 6
Typical Example of Key Stream Information for
Pressure Swing Adsorption (PSA) Only Separation

| | | Stream # | | | | | |
|---|---|---|---|---|---|---|---|
| | Units | 275 | 430 | | 415 | 440 | |
| Stream | | Compressed | CO₂ Product | | CO Containing | Portion of | |
| Description | | Reactor | | | Overhead | Intermediate | |
| | | Effluent | | | | Pressure CO₂ | |
| | | | | | | Containing Stream | |
| Temperature | ° F. | 122 | 120 | | 85 | 120 | |
| Pressure | psig | 200 | 1030 | | 190 | 50 | |
| Molar Flow | lbmol/hr | 18164 | 2396 | | 940 | 14721 | |
| Mass Flow | lb/hr | 781588 | 105178 | | 28390 | 646093 | |
| Composition | mol % | | | | | | |
| H₂O | | 0.6 | 0 | | 0 | 0.6 | |
| O₂ | | 0.3 | <600 | ppm | 4.0 | <600 | ppm |
| N₂ | | 0.1 | <200 | ppm | 2.0 | <200 | ppm |
| CO | | 4.9 | 0.7 | | 12.7 | 0.7 | |
| CO₂ | | 94.1 | 99.2 | | 81.3 | 98.6 | |
| SO₂ | | <10 ppm | <10 | ppm | 0 | <10 | ppm |
| SO₃ | | <10 ppm | <10 | ppm | 0 | <10 | ppm |
| NO | | <10 ppm | <10 | ppm | <50 ppm | <10 | ppm |
| NO₂ | | <10 ppm | <10 | ppm | 0 | <10 | ppm |

### Example 4

An example case was developed for the pressure swing adsorption (PSA) separation case followed by an additional CO purification step. The required CO purity dictates the technology type/s that is/are selected for this additional purification step. In this example, the additional CO purification step is a pressure swing adsorption (PSA) unit. Key material balances from streams up to the CO₂ capture system can be found in Table 7. Temperatures, pressures, and overall mass flow rate for the section upstream of the CO₂ capture system can vary depending on upstream FCC unit operation and the specific composition of the CO₂ recycle stream from the downstream CO₂ separation unit.

TABLE 7
Typical Example of Key Stream Information Upstream of CO₂ Capture System for Pressure
Swing Adsorption (PSA) with Additional Pressure Swing Adsorption (PSA) Separation

| | | Stream # | | | | | |
|---|---|---|---|---|---|---|---|
| | Units | 145 | 135 | 150 | 185 | 220 | 253 |
| Stream | | Concentrated | Mixture of | Partially | Cooled | Reactor | Cooled |
| Description | | O₂ | Preheated CO₂ | Combusted | Flue Gas | Effluent | Reactor |
| | | | Recycle and | Flue Gas | Stream | | Effluent |
| | | | Concentrated O₂ | | | | |
| Temperature | ° F. | 90 | 291 | 1317 | 450 | 450 | 120 |
| Pressure | psig | 50 | 32 | 19 | 3 | 2 | 0.25 |
| Molar Flow | lbmol/ | 3819 | 18540 | 19857 | 19857 | 19843 | 19843 |
| | hr | | | | | | |
| Mass Flow | lb/hr | 122124 | 768311 | 812924 | 812924 | 812001 | 812001 |
| Composition | mol % | | | | | | |
| H₂O | | 0 | 0 | 9.0 | 9.0 | 9.0 | 9.0 |
| O₂ | | 99.5 | 20.5 | 0.2 | 0.2 | 0.2 | 0.2 |
| N₂ | | 0.5 | 0.1 | 0.1 | 0.1 | 0.1 | 0.1 |
| CO | | 0 | 0.5 | 4.4 | 4.4 | 4.5 | 4.5 |
| CO₂ | | 0 | 78.8 | 86.2 | 86.2 | 86.2 | 86.2 |
| SO₂ | | 0 | Trace | <1000 ppm | <1000 ppm | <10 ppm | <10 ppm |
| SO₃ | | 0 | Trace | <1000 ppm | <1000 ppm | <10 ppm | <10 ppm |
| NO | | 0 | Trace | <1000 ppm | <1000 ppm | <10 ppm | <10 ppm |
| NO₂ | | 0 | Trace | <1000 ppm | <1000 ppm | <10 ppm | <10 ppm |

The CO and CO₂ product stream material balances can be seen in Table 8. The initial PSA step targets CO₂ recovery, as described in the previous example and has the same flexibility regarding CO₂ stream purity and CO stream purity. An additional separation step (in this example, another PSA unit) it used to increase the CO stream purity. The additional separation step can increase CO stream purity to more than 75 mol %, but its design can be tailored to target a specific CO purity. An inert purge stream may be needed to remove any inert gas build up in the system to achieve the higher CO product purity.

TABLE 8
Typical Example of Key Stream Information for Pressure Swing Adsorption
(PSA) with Additional Pressure Swing Adsorption (PSA) Separation

| | | Stream # | | | | |
|---|---|---|---|---|---|---|
| | Units | 275 | 430 | 450 | 440 | N/A |
| Stream | | Compressed | CO₂ | CO | Portion of | Inert |
| Description | | Reactor | Product | Product | Intermediate | Purge |
| | | Effluent | | | Pressure CO₂ | |
| | | | | | Containing Stream | |
| Temperature | ° F. | 122 | 120 | 85 | 120 | 85 |
| Pressure | psig | 200 | 1030 | 5 | 50 | 180 |
| Molar Flow | lbmol/hr | 18164 | 2396 | 885 | 14721 | 21 |
| Mass Flow | lb/hr | 781588 | 105178 | 26695 | 646093 | 604 |
| Composition | mol % | | | | | |
| H₂O | | 0.6 | 0 | 0 | 0.6 | 0 |
| O₂ | | 0.3 | <600 ppm | <200 ppm | <600 ppm | 22.1 |
| N₂ | | 0.1 | <200 ppm | <500 ppm | <200 ppm | 77.8 |
| CO | | 4.9 | 0.7 | 86.3 | 0.7 | 0 |
| CO₂ | | 94.1 | 99.2 | 13.5 | 98.6 | 0 |
| SO₂ | | <10 ppm | <10 ppm | 0 | <10 ppm | 0 |
| SO₃ | | <10 ppm | <10 ppm | 0 | <10 ppm | 0 |
| NO | | <10 ppm | <10 ppm | <10 ppm | <10 ppm | 0.1 |
| NO₂ | | <10 ppm | <10 ppm | 0 | <10 ppm | 0 |

### Example 5

An example case was developed for the temperature swing adsorption (TSA) only separation case. For this example, the heat exchanger network is slightly modified from the description of the process upstream of the CO₂ separation unit, which allows for the option of heat integration with the temperature swing adsorption regeneration loop. Additionally, equipment numbers are slightly different from the generic description above. Key material balances from streams up to the CO₂ capture system can be found in Table 9. Temperatures, pressures, and overall mass flow rate for the section upstream of the CO₂ capture system can vary depending on upstream FCC unit operation and the specific composition of the CO₂ recycle stream from the downstream CO₂ separation unit.

TABLE 9
Typical Example of Key Stream Information Upstream of CO₂ Capture
System for Temperature Swing Adsorption (TSA) Only Separation

| | | Stream # | | | | | |
|---|---|---|---|---|---|---|---|
| | Units | 145 | 135 | 150 | 185 | 220 | 529 |
| Stream | | Concentrated | Mixture of | Partially | Cooled | Reactor | Cooled |
| Description | | O₂ | Preheated CO₂ | Combusted | Flue Gas | Effluent | Reactor |
| | | | Recycle and | Flue Gas | Stream | | Effluent |
| | | | Concentrated O₂ | | | | |
| Temperature | ° F. | 90 | 291 | 1317 | 450 | 450 | 120 |
| Pressure | psig | 50 | 32 | 19 | 3 | 2 | 0.25 |
| Molar Flow | lbmol/ | 3788 | 18782 | 20100 | 20100 | 20086 | 20086 |
| | hr | | | | | | |
| Mass Flow | lb/hr | 121063 | 778853 | 823469 | 823469 | 822546 | 822546 |
| Composition | mol % | | | | | | |
| H₂O | | 0 | 0 | 8.8 | 8.8 | 9.0 | 9.0 |
| O₂ | | 99.5 | 20.3 | 0.2 | 0.2 | 0.2 | 0.2 |
| N₂ | | 0.5 | 0.7 | 0.6 | 0.6 | 0.1 | 0.1 |
| CO | | 0 | 0.0 | 3.9 | 3.9 | 4.5 | 4.5 |
| CO₂ | | 0 | 79.1 | 86.3 | 86.3 | 86.4 | 86.4 |
| SO₂ | | 0 | Trace | <1000 ppm | <1000 ppm | <10 ppm | <10 ppm |
| SO₃ | | 0 | Trace | <1000 ppm | <1000 ppm | <10 ppm | <10 ppm |
| NO | | 0 | Trace | <1000 ppm | <1000 ppm | <10 ppm | <10 ppm |
| NO₂ | | 0 | Trace | <1000 ppm | <1000 ppm | <10 ppm | <10 ppm |

The CO and CO₂ product stream material balances can be seen in Table 10. For this case, a relatively high purity for both CO₂ stream (97%+) and CO stream (80%+) typically possible, although the system can be designed to target the specific purity needed. The CO in this case can be delivered at a high pressure (as shown in the example below), but lower pressure delivery is possible.

TABLE 10
Typical Example of Key Stream Information for Temperature
Swing Adsorption (TSA) Only Separation

| | | Stream # | | | | |
|---|---|---|---|---|---|---|
| | | | Difference of | | | |
| | Units | 550 | 560 & 580 | 620 | | 580 |
| Stream | | Compressed | CO₂ | CO Product | | Portion of CO₂ |
| Description | | Reactor | Containing | Stream | | Containing |
| | | Effluent | Stream | | | Stream |
| Temperature | ° F. | 122 | 85 | 120 | | 85 |
| Pressure | psig | 150 | 140 | 1030 | | 140 |
| Molar Flow | lbmol/hr | 18410 | 2541 | 772 | | 14989 |
| Mass Flow | lb/hr | 792284 | 111488 | 21835 | | 657450 |
| Composition | mol % | | | | | |
| H₂O | | 0.6 | 0 | 0 | | 0 |
| O₂ | | 0.3 | 0.3 | <300 | ppm | 0.3 |
| N₂ | | 0.6 | 0.7 | <800 | ppm | 0.7 |
| CO | | 4.3 | 0 | 90.0 | | 0 |
| CO₂ | | 94.2 | 99.0 | 9.9 | | 99.0 |
| SO₂ | | <10 ppm | <10 ppm | <10 | ppm | <10 ppm |
| SO₃ | | <10 ppm | <10 ppm | <10 | ppm | <10 ppm |
| NO | | <10 ppm | <10 ppm | <10 | ppm | <10 ppm |
| NO₂ | | <10 ppm | <10 ppm | <10 | ppm | <10 ppm |

The 5 examples above illustrate that the purification of both CO and CO₂ product streams can be achieved by different technologies to different purity levels. The selection of which technology approach to use for a specific purification step will depend on the combination of the required CO and CO₂ product requirements, including purity, temperature, and pressure. The above examples merely represent specific case studies, and modifications to the designs can lead to different product specifications achieved in each example. The two cryogenic fractionation routes provide the most overall flexibility to both CO and CO₂ product streams, with the TSA only solution having the next most flexibility. The two PSA solutions are envisioned to be more case specific, especially the PSA only solution due to the lower product purity of CO stream. Adding a CO separation unit to the PSA only case yields CO stream purities similar to the other examples provided.

### Specific Embodiments

While the following is described in conjunction with specific embodiments, it will be understood that this description is intended to illustrate and not limit the scope of the preceding description and the appended claims.

A first embodiment of the invention is a process for separating CO from CO₂ in a flue gas stream from a partial oxidation regenerator of a fluid catalytic cracking (FCC) process comprising passing a mixture of a preheated CO₂ recycle stream and a concentrated oxygen stream to the partial oxidation regenerator to generate the flue gas stream comprising CO₂, CO, SOx, NOx, catalyst fines, O₂, and H₂O; transferring heat from the flue gas stream to a boiler feed water stream in a heat recovery section to form a partially cooled flue gas stream and a steam stream; reacting one or more of a sulfur-containing compound, a nitrogen-containing compound, or both in the flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream; heating a CO₂ recycle stream with the reactor effluent gas stream to produce the preheated CO₂ recycle stream and a cooled reactor effluent stream; and separating the cooled reactor effluent stream into a CO₂ product stream, the CO₂ recycle stream, and a CO product stream. An embodiment of the invention is one, any or all of prior embodiments in this paragraph up through the first embodiment in this paragraph wherein separating the reactor effluent stream into the CO₂ product stream, the CO₂ recycle stream, and the CO product stream comprises compressing the cooled reactor effluent stream in a compressor to form a compressed reactor effluent stream; dehydrating the compressed reactor effluent stream to form a dehydrated reactor effluent stream; separating the dehydrated reactor effluent stream into the CO₂ product stream and a CO-containing overhead stream in a cryogenic CO₂ fractionation system; and separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof. An embodiment of the invention is one, any or all of prior embodiments in this paragraph up through the first embodiment in this paragraph further comprising compressing or expanding the recycle CO₂ stream before introducing the CO₂ recycle stream into the regenerator. An embodiment of the invention is one, any or all of prior embodiments in this paragraph up through the first embodiment in this paragraph further comprising recycling a portion of the CO₂ recycle stream to the compressor. An embodiment of the invention is one, any or all of prior embodiments in this paragraph up through the first embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream is the CO₂ recycle stream. An embodiment of the invention is one, any or all of prior embodiments in this paragraph up through the first embodiment in this paragraph wherein separating the reactor effluent stream into the CO₂ product stream, the CO₂ recycle stream, and the CO product stream comprises compressing the cooled reactor effluent stream in a compressor to form a compressed reactor effluent stream; separating the compressed reactor effluent stream into a low pressure CO₂-containing stream and a high pressure CO-containing stream in a pressure swing absorption (PSA) unit or a vacuum swing adsorption (VPSA) unit; compressing the low pressure CO₂-containing stream to form a high pressure CO2-containing stream and an intermediate pressure CO₂-containing stream; co-feeding the intermediate pressure CO₂-containing stream to the PSA or VPSA unit; dehydrating the high pressure CO₂-containing stream to form the CO₂ product stream; purifying the high pressure CO-containing stream in a polishing section to form the CO product stream and wherein a part of the intermediate pressure CO₂-containing stream comprises the CO₂ recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof. An embodiment of the invention is one, any or all of prior embodiments in this paragraph up through the first embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream comprises the CO₂ recycle stream. An embodiment of the invention is one, any or all of prior embodiments in this paragraph up through the first embodiment in this paragraph wherein separating the reactor effluent stream into the CO₂ product stream, the CO₂ recycle stream, and the CO product stream comprises compressing the cooled reactor effluent stream in a compressor to form a compressed reactor effluent stream; separating the compressed reactor effluent stream into a CO₂-containing stream and a CO-containing stream in a temperature swing absorption (TSA) unit; compressing the CO₂-containing stream to form the CO₂ product stream; compressing the CO-containing stream to form a high pressure CO stream; dehydrating the high pressure CO-containing stream to form the CO product stream; wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof. An embodiment of the invention is one, any or all of prior embodiments in this paragraph up through the first embodiment in this paragraph further comprising dividing the CO-containing stream from the TSA unit into a first part and a second part, wherein the first part is compressed to form the high pressure CO stream; compressing and cooling the second portion of the CO-containing stream and optionally removing water from the cooled, compressed second portion of the CO-containing stream water removal; heating the cooled, compressed second portion of the CO-containing stream to form a heated second portion of the CO-containing stream; introducing the heated second portion of the CO-containing stream to the TSA unit. An embodiment of the invention is one, any or all of prior embodiments in this paragraph up through the first embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream; or wherein the compressed portion of the cooled reactor effluent stream comprises the CO₂ recycle stream. An embodiment of the invention is one, any or all of prior embodiments in this paragraph up through the first embodiment in this paragraph further comprising further cooling the cooled reactor effluent stream and removing water from the cooled reactor effluent stream before separating the cooled reactor effluent stream. An embodiment of the invention is one, any or all of prior embodiments in this paragraph up through the first embodiment in this paragraph further comprising recovering heat from the reactor effluent stream before cooling the reactor effluent stream. An embodiment of the invention is one, any or all of prior embodiments in this paragraph up through the first embodiment in this paragraph further comprising introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of the sulfur-containing compound in the flue gas stream with the reactant in the decontamination reactor comprises reacting one or more of the sulfur-containing compound in the partially cooled flue gas stream with the reactant. An embodiment of the invention is one, any or all of prior embodiments in this paragraph up through the first embodiment in this paragraph wherein the concentrated oxygen stream is made in an air separation unit or an electrolyzer. An embodiment of the invention is one, any or all of prior embodiments in this paragraph up through the first embodiment in this paragraph wherein reacting one or more of the sulfur-containing compound, the nitrogen-containing compound, or both in the flue gas stream with the reactant in the decontamination reactor comprises reacting the flue gas stream with a reactant in a dry SOx reaction section to form a dry SOx reaction section flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOx, wherein the reactant comprises at least one of NaHCO₃, NaHCO₃·Na₂CO₃·2(H₂O), CaCO₃, Ca(OH)₂, and Mg(OH)₂; and filtering the dry SOx reaction section flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form the reactor effluent stream and a filtered material stream.

A second embodiment of the invention is a process for separating CO from CO₂ in a flue gas stream from a partial oxidation regenerator of a fluid catalytic cracking (FCC) process comprising passing a mixture of a preheated CO2 recycle stream and a concentrated oxygen stream to the partial oxidation regenerator to generate the flue gas stream comprising CO₂, CO, SOx, NOx, catalyst fines, O and H₂O; transferring heat from the flue gas stream to a boiler feed water stream in a heat recovery section to form a partially cooled flue gas stream and a steam stream; heating a CO₂ recycle stream with the partially cooled flue gas stream to produce the preheated CO₂ recycle stream and a cooled flue gas stream; reacting one or more of a sulfur-containing compound in the cooled flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream; and separating the reactor effluent stream into a CO2 product stream, the CO₂ recycle stream, and a CO product stream; and wherein reacting one or more of the sulfur-containing compound in the cooled flue gas stream with the reactant in the decontamination reactor comprises reacting a caustic solution or an NH3 based solution with the cooled flue gas stream in a wet SOx reaction section to form the reactor effluent flue gas stream and a liquid stream comprising at least one of H₂O, CO, CO, N₂, O², Na₂SO₃, Na₂SO₄, NaHSO₃, Na₂CO₃, (NH₄)2SO₄, and catalyst fines. An embodiment of the invention is one, any or all of prior embodiments in this paragraph up through the second embodiment in this paragraph further comprising cooling the reactor effluent stream before separating the reactor effluent stream. An embodiment of the invention is one, any or all of prior embodiments in this paragraph up through the second embodiment in this paragraph wherein separating the reactor effluent stream into the CO₂ product stream, the CO₂ recycle stream, and the CO product stream comprises compressing the cooled reactor effluent stream in a compressor to form a compressed reactor effluent stream; dehydrating the compressed reactor effluent stream to form a dehydrated reactor effluent stream; separating the dehydrated reactor effluent stream into the CO₂ product stream and a CO-containing overhead stream in a cryogenic CO₂ fractionation system; and separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof. An embodiment of the invention is one, any or all of prior embodiments in this paragraph up through the second embodiment in this paragraph further comprising compressing or expanding the recycle CO₂ stream before introducing the CO₂ recycle stream into the regenerator. An embodiment of the invention is one, any or all of prior embodiments in this paragraph up through the second embodiment in this paragraph further comprising recycling a portion of the CO₂ recycle stream to the compressor. An embodiment of the invention is one, any or all of prior embodiments in this paragraph up through the second embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream is the CO2 recycle stream. An embodiment of the invention is one, any or all of prior embodiments in this paragraph up through the second embodiment in this paragraph wherein separating the reactor effluent stream into the CO₂ product stream, the CO₂ recycle stream, and the CO product stream comprises compressing the cooled reactor effluent stream in a compressor to form a compressed reactor effluent stream; separating the compressed reactor effluent stream into a low pressure CO₂-containing stream and a high pressure CO-containing stream in a pressure swing absorption (PSA) unit or a vacuum swing adsorption (VPSA) unit; compressing the low pressure CO₂-containing stream to form a high pressure CO₂-containing stream and an intermediate pressure CO₂-containing stream; co-feeding the intermediate pressure CO₂-containing stream to the PSA or VPSA unit; dehydrating the high pressure CO₂-containing stream to form the CO₂ product stream; purifying the high pressure CO-containing stream in a polishing section to form the CO product stream and wherein a part of the intermediate pressure CO₂-containing stream comprises the CO2 recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof. An embodiment of the invention is one, any or all of prior embodiments in this paragraph up through the second embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream, or wherein the compressed portion of the cooled reactor effluent stream comprises the CO₂ recycle stream. An embodiment of the invention is one, any or all of prior embodiments in this paragraph up through the second embodiment in this paragraph wherein separating the reactor effluent stream into the CO₂ product stream, the CO2 recycle stream, and the CO product stream comprises compressing the cooled reactor effluent stream in a compressor to form a compressed reactor effluent stream; separating the compressed reactor effluent stream into a CO₂-containing stream and a CO-containing stream in a temperature swing absorption (TSA) unit; compressing the CO₂-containing stream to form the CO₂ product stream; compressing the CO-containing stream to form a high pressure CO stream; dehydrating the high pressure CO-containing stream to form the CO product stream; wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof. An embodiment of the invention is one, any or all of prior embodiments in this paragraph up through the second embodiment in this paragraph further comprising dividing the CO-containing stream from the TSA unit into a first part and a second part, wherein the first part is compressed to form the high pressure CO stream; compressing and cooling the second portion of the CO-containing stream and optionally removing water from the cooled, compressed second portion of the CO-containing stream water removal; heating the cooled, compressed second portion of the CO-containing stream to form a heated second portion of the CO-containing stream; introducing the heated second portion of the CO-containing stream to the TSA unit. An embodiment of the invention is one, any or all of prior embodiments in this paragraph up through the second embodiment in this paragraph further comprising separating water from the cooled reactor effluent stream in a knockout drum before compressing the cooled reactor effluent stream; compressing a portion of the cooled reactor effluent stream from the knockout drum; and combining the compressed portion of the cooled reactor effluent stream with the CO₂ recycle stream; or wherein the compressed portion of the cooled reactor effluent stream comprises the CO₂ recycle stream. An embodiment of the invention is one, any or all of prior embodiments in this paragraph up through the second embodiment in this paragraph further comprising further cooling the cooled reactor effluent stream and removing water from the cooled reactor effluent stream before separating the cooled reactor effluent stream. An embodiment of the invention is one, any or all of prior embodiments in this paragraph up through the second embodiment in this paragraph further comprising recovering heat from the reactor effluent stream before cooling the reactor effluent stream. An embodiment of the invention is one, any or all of prior embodiments in this paragraph up through the second embodiment in this paragraph further comprising introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section; introducing a boiler feed water stream and the partially cooled flue gas stream into the saturated steam section to produce a saturated steam stream and a second partially cooled flue gas stream; introducing at least a portion of the saturated steam stream into the superheated steam section; superheating the saturated steam stream with the flue gas stream to produce the superheated steam stream; and wherein reacting one or more of the sulfur-containing compound, the nitrogen-containing compound, or both in the flue gas stream with the reactant in the decontamination reactor comprises reacting one or more of the sulfur-containing compound, the nitrogen-containing compound, or both in the partially cooled flue gas stream with the reactant. An embodiment of the invention is one, any or all of prior embodiments in this paragraph up through the second embodiment in this paragraph wherein the concentrated oxygen stream is made in an air separation unit or an electrolyzer.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A process for separating CO from CO₂ in a flue gas stream from a partial oxidation regenerator of a fluid catalytic cracking (FCC) process comprising:
passing a mixture of a preheated CO₂ recycle stream and a concentrated oxygen stream to the partial oxidation regenerator to generate the flue gas stream comprising CO₂, CO, SOx, NOx, catalyst fines, O₂, and H₂O;
transferring heat from the flue gas stream to a boiler feed water stream in a heat recovery section to form a partially cooled flue gas stream and a steam stream;
reacting one or more of a sulfur-containing compound in the flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream;
heating a CO₂ recycle stream with the reactor effluent gas stream to produce the preheated CO₂ recycle stream and a cooled reactor effluent stream; and
separating the cooled reactor effluent stream into a CO₂ product stream, the CO₂ recycle stream, and a CO product stream.

2. The process of claim 1 wherein separating the reactor effluent stream into the CO₂ product stream, the CO₂ recycle stream, and the CO product stream comprises:
compressing the cooled reactor effluent stream in a compressor to form a compressed reactor effluent stream;
dehydrating the compressed reactor effluent stream to form a dehydrated reactor effluent stream;
separating the dehydrated reactor effluent stream into the CO₂ product stream and a CO-containing overhead stream in a cryogenic CO₂ fractionation system; and
separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof.

3. The process of claim 2 further comprising:
compressing or expanding the recycle CO₂ stream before introducing the CO₂ recycle stream into the regenerator.

4. The process of claim 2 further comprising:
recycling a portion of the CO₂ recycle stream to the compressor.

5. The process of claim 2 further comprising:
separating water from the cooled reactor effluent stream in a knockout drum before compressing the cooled reactor effluent stream;
compressing a portion of the cooled reactor effluent stream from the knockout drum; and
combining the compressed portion of the cooled reactor effluent stream with the CO₂ recycle stream, or wherein the compressed portion of the cooled reactor effluent stream is the CO₂ recycle stream.

6. The process of claim 1 wherein separating the reactor effluent stream into the CO₂ product stream, the CO₂ recycle stream, and the CO product stream comprises:
compressing the cooled reactor effluent stream in a compressor to form a compressed reactor effluent stream;
separating the compressed reactor effluent stream into a low pressure CO₂-containing stream and a high pressure CO-containing stream in a pressure swing absorption (PSA) unit or a vacuum swing adsorption (VPSA) unit;
compressing the low pressure CO₂-containing stream to form a high pressure CO₂-containing stream and an intermediate pressure CO₂-containing stream;
co-feeding the intermediate pressure CO₂-containing stream to the PSA or VPSA unit;
dehydrating the high pressure CO₂-containing stream to form the CO₂ product stream; and
purifying the high pressure CO-containing stream in a polishing section to form the CO product stream and wherein a part of the intermediate pressure CO₂-containing stream comprises the CO₂ recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof.

7. The process of claim 6 further comprising:
separating water from the cooled reactor effluent stream in a knockout drum before compressing the cooled reactor effluent stream;
compressing a portion of the cooled reactor effluent stream from the knockout drum; and
combining the compressed portion of the cooled reactor effluent stream with the CO₂ recycle stream, or wherein the compressed portion of the cooled reactor effluent stream comprises the CO₂ recycle stream.

8. The process of claim 1 wherein separating the reactor effluent stream into the CO₂ product stream, the CO₂ recycle stream, and the CO product stream comprises:
compressing the cooled reactor effluent stream in a compressor to form a compressed reactor effluent stream;
separating the compressed reactor effluent stream into a CO₂-containing stream and a CO-containing stream in a temperature swing absorption (TSA) unit;
compressing the CO₂-containing stream to form the CO₂ product stream;
compressing the CO-containing stream to form a high pressure CO stream; and
dehydrating the high pressure CO-containing stream to form the CO product stream;
wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof.

9. The process of claim 8 further comprising:
dividing the CO-containing stream from the TSA unit into a first part and a second part, wherein the first part is compressed to form the high pressure CO stream;
compressing and cooling the second portion of the CO-containing stream and optionally removing water from the cooled, compressed second portion of the CO-containing stream water removal;
heating the cooled, compressed second portion of the CO-containing stream to form a heated second portion of the CO-containing stream; and
introducing the heated second portion of the CO-containing stream to the TSA unit.

10. The process of claim 8 further comprising:
separating water from the cooled reactor effluent stream in a knockout drum before compressing the cooled reactor effluent stream;
compressing a portion of the cooled reactor effluent stream from the knockout drum; and
combining the compressed portion of the cooled reactor effluent stream with the CO₂ recycle stream; or wherein the compressed portion of the cooled reactor effluent stream comprises the CO₂ recycle stream.

11. The process of claim 1 further comprising:
further cooling the cooled reactor effluent stream and removing water from the cooled reactor effluent stream before separating the cooled reactor effluent stream.

12. The process of claim 1 further comprising:
recovering heat from the reactor effluent stream before cooling the reactor effluent stream.

13. The process of claim 1 further comprising:
introducing the flue gas stream into a superheated steam section of a heat recovery steam generator (HRSG) before the decontamination reactor to produce a superheated steam stream and a partially cooled flue gas stream, the HRSG comprising the superheated steam section and a saturated steam section;
introducing a boiler feed water stream and the partially cooled flue gas stream into the saturated steam section to produce a saturated steam stream and a second partially cooled flue gas stream;
introducing at least a portion of the saturated steam stream into the superheated steam section;
superheating the saturated steam stream with the flue gas stream to produce the superheated steam stream; and
wherein reacting one or more of the sulfur-containing compound, the nitrogen-containing compound, or both in the flue gas stream with the reactant in the decontamination reactor comprises reacting one or more of the sulfur-containing compound, the nitrogen-containing compound, or both in the partially cooled flue gas stream with the reactant.

14. The process of claim 1 wherein the concentrated oxygen stream is made in an air separation unit or an electrolyzer.

15. The process of claim 1 wherein reacting one or more of the sulfur-containing compound in the flue gas stream with the reactant in the decontamination reactor comprises:
reacting the flue gas stream with a reactant in a dry SOx reaction section to form a dry SOx reaction section flue gas stream consisting essentially of at least one of H₂O, CO₂, CO, N₂, O₂, Na₂CO₃, Na₂SO₄, NaNO₃, CaSO₄, CaCO₃, Ca(NO₃)₂, MgCO₃, MgSO₄, Mg(NO₃)₂, and NOx, wherein the reactant comprises at least one of NaHCO₃, NaHCO₃·Na₂CO₃·2(H₂O), CaCO₃, Ca(OH)₂, and Mg(OH)₂; and
filtering the dry SOx reaction section flue gas stream in a filtration section to remove Na₂CO₃, Na₂SO₄, NaNO₃, CaSO₄, CaCO₃, Ca(NO₃)₂, MgCO₃, MgSO₄, Mg(NO₃)₂ and catalyst fines to form the reactor effluent stream and a filtered material stream.

16. A process for separating CO from CO₂ in a flue gas stream from a partial oxidation regenerator of a fluid catalytic cracking (FCC) process comprising:
passing a mixture of a preheated CO₂ recycle stream and a concentrated oxygen stream to the partial oxidation regenerator to generate the flue gas stream comprising CO₂, CO, SOx, NOx, catalyst fines, O₂ and H₂O;
transferring heat from the flue gas stream to a boiler feed water stream in a heat recovery section to form a partially cooled flue gas stream and a steam stream;
heating a CO₂ recycle stream with the partially cooled flue gas stream to produce the preheated CO₂ recycle stream and a cooled flue gas stream;
reacting one or more of a sulfur-containing compound, in the cooled flue gas stream with a reactant in a decontamination reactor to form a reactor effluent flue gas stream and a contaminant stream, the reactor effluent gas stream having a level of the sulfur-containing compound less than a level of the sulfur-containing compound in the flue gas stream;
separating the reactor effluent stream into a CO₂ product stream, the CO₂ recycle stream, and a CO product stream; and
wherein reacting one or more of the sulfur-containing compound, the nitrogen-containing compound, or both in the cooled flue gas stream with the reactant in the decontamination reactor comprises:
reacting a caustic solution or an NH₃ based solution with the cooled flue gas stream in a wet SOx reaction section to form the reactor effluent flue gas stream and a liquid stream comprising at least one of H₂O, CO₂, CO, N₂, O₂, Na₂SO₃, Na₂SO₄, NaHSO₃, Na₂CO₃, (NH₄)₂SO₄, and catalyst fines.

17. The process of claim 16 further comprising:
cooling the reactor effluent stream before separating the reactor effluent stream.

18. The process of claim 16 wherein separating the reactor effluent stream into the CO₂ product stream, the CO₂ recycle stream, and the CO product stream comprises:
compressing the cooled reactor effluent stream in a compressor to form a compressed reactor effluent stream;
dehydrating the compressed reactor effluent stream to form a dehydrated reactor effluent stream;
separating the dehydrated reactor effluent stream into the CO₂ product stream and a CO-containing overhead stream in a cryogenic CO₂ fractionation system; and
separating the CO-containing overhead stream into the CO₂ recycle stream and the CO product stream in a separation section; or recycling a portion of the CO₂ product stream as the CO₂ recycle stream and wherein the CO-containing overhead stream comprises the CO product stream; or compressing a portion of the cooled reactor effluent stream to form the CO₂ recycle stream and wherein the CO-containing overhead stream comprises the CO product stream; or wherein a portion of the compressed reactor effluent stream comprises the CO₂ recycle stream and wherein the CO-containing overhead stream comprises the CO product stream; or combinations thereof.

19. The process of claim 16 wherein separating the reactor effluent stream into the CO₂ product stream, the CO₂ recycle stream, and the CO product stream comprises:
compressing the cooled reactor effluent stream in a compressor to form a compressed reactor effluent stream;
separating the compressed reactor effluent stream into a low pressure CO₂-containing stream and a high pressure CO-containing stream in a pressure swing absorption (PSA) unit or a vacuum swing adsorption (VPSA) unit;
compressing the low pressure CO₂-containing stream to form a high pressure CO₂-containing stream and an intermediate pressure CO₂-containing stream;
co-feeding the intermediate pressure CO₂-containing stream to the PSA or VPSA unit;
dehydrating the high pressure CO₂-containing stream to form the CO₂ product stream; and
purifying the high pressure CO-containing stream in a polishing section to form the CO product stream and wherein a part of the intermediate pressure CO₂-containing stream comprises the CO₂ recycle stream; or purifying the high pressure CO-containing stream in a polishing section to form the CO product stream and compressing a portion of the cooled reactor effluent stream to form the CO₂ recycle stream; or purifying the high pressure CO-containing stream in a polishing section to form the CO product stream and wherein a portion of the compressed reactor effluent stream comprises the CO₂ recycle stream; or wherein the high pressure CO-containing stream comprises the CO product stream; and wherein a part of the intermediate pressure CO₂-containing stream comprises the CO₂ recycle stream; or wherein the high pressure CO-containing stream comprises the CO product stream and compressing a portion of the cooled reactor effluent stream to form the CO₂ recycle stream; or wherein the high pressure CO-containing stream comprises the CO product stream and wherein a portion of the compressed reactor effluent stream comprises the CO₂ recycle stream; or combinations thereof.

20. The process of claim 16 wherein separating the reactor effluent stream into the CO₂ product stream, the CO₂ recycle stream, and the CO product stream comprises:
compressing the cooled reactor effluent stream in a compressor to form a compressed reactor effluent stream;
separating the compressed reactor effluent stream into a CO₂-containing stream and a CO-containing stream in a temperature swing absorption (TSA) unit;
compressing the CO₂-containing stream to form the CO₂ product stream;
compressing the CO-containing stream to form a high pressure CO stream; and
dehydrating the high pressure CO-containing stream to form the CO product stream;
wherein a part of the CO₂-containing stream comprises the CO₂ recycle stream; or compressing a portion of the cooled reactor effluent stream to form the CO₂ recycle stream; or a portion of the compressed reactor effluent stream comprises the CO₂ recycle stream; or combinations thereof.
